(19) United States
(12) Patent Application Publication
(10) Pub. No.: US 2008/0091455 A1
(43) Pub. Date: Apr. 17, 2008

(54) AUTOMATED METHOD FOR RECEIVING AND EVALUATING JOB APPLICATIONS USING A WEB-BASED SYSTEM

(75) Inventors: Bridget Dongara, Lexington, VA (US); Valerie Duhart, Lizella, GA (US); Dennis Harp, Fairfax, VA (US); Kim Leotis, Warner Robins, GA (US); J. Patrick Sharpe, Falling Waters, WV (US); Van Yee, Beltsville, MD (US)

Correspondence Address: Gary L. Hausken, United States Department of Justice, Civil Division, Washington, DC, 20530, US

(73) Assignee: The United States of America as represented by the Director of the Office of Personnel Management, Washington, DC (US)

(21) Appl. No.: 11/870,865

(22) Filed: Oct. 11, 2007

Related U.S. Application Data
(60) Provisional application No. 60/850,596, filed on Oct. 11, 2006.

(51) Int. Cl. G06Q 10/00

(52) U.S. Cl. 705/1

(57) ABSTRACT

An automated, Web-based system and method for rating a candidate for employment, wherein an application and/or resume are submitted electronically and are subjected to an automated review process, wherein the applicant's qualifications may be first rated against a minimal, pre-selected set of employment criteria, and wherein the application, if it passes the initial screen, is subsequently screened against a more robust, pre-selected set of rating criteria to determine qualification for a particular position or set of positions. The invention also includes the ability to automate the scoring and rating of written narrative responses provided by job applicants, wherein the computerized method implements preselected methods of obtaining consensus, if required, between individual raters and then applies the scores in a predefined manner to obtain a final rating for the applicant.

### CROSS-REFERENCES TO RELATED APPLICATIONS

This application claims priority under 35 U.S.C. § 119(e) to U.S. Provisional Patent Application No. 60/850,596, filed on Oct. 11, 2006, the disclosure of which is incorporated by reference in its entirety herein.

### STATEMENT REGARDING FEDERALLY SPONSORED RESEARCH OR DEVELOPMENT

The claimed invention was developed by an agency of the United States government; the Federal government therefore has certain rights in the invention.

### BACKGROUND OF THE INVENTION

The invention relates generally to a Web-based automated staffing system. More specifically, the invention relates to an automated staffing system capable of rating candidates' application packages against multiple positions having different educational or work experience qualifications. The invention further relates to a method of automating a portion of the ratings process for applications containing written narrative responses.

Numerous methods of staffing vacant employment positions exist in the prior art. These prior art methods are conducted using a broad array of methods including manual screening and scoring, punch-card systems, computerized local area networks, and the Internet. In general, these methods are cumbersome and incapable of quickly and efficiently matching an applicant's qualifications against a predefined set of employment criteria. They are also difficult to implement in nationwide or global employment settings.

Job vacancies in the Government and large corporations are characterized by extremes. Many positions are either very hard to fill due to a lack of qualified applicants, or are so popular that even a very short open period results in extremely large numbers of applications, in some cases in the hundreds of thousands. All of these applications must be processed before a referral list can be issued.

Due to the large volumes, when the methods of the invention are not used, it is not uncommon for it to take several months to prepare a referral list, even for critical vacancies. The time and expense of rating applicants is increased because unqualified applicants are rated and processed at the same rate as qualified applicants. For large employers, a significant risk exists that the delay in processing applications will result in highly qualified applicants accepting positions with other employers before even an initial rating can be completed for a particular job announcement.

The prior art systems rely heavily upon closed-ended multiple choice questionnaires wherein the applicant self-reports his or her experience. Such questionnaires provide no means for applicants to describe their experience and qualifications in their own words or to use narrative responses. Thus, often the only available method of evaluating an applicant is also the least valid as a predictor of successful job performance and job satisfaction; more effective assessment procedures are out of reach due to the cost or the length of time required to complete the evaluation process.

In contrast, the present invention is capable of quickly and efficiently screening applicants for a wide variety of positions in an automated fashion. The present invention is also capable of using a deferred rating process, wherein applicants are initially screened against only minimal rating criteria, usually to determine if the applicant possesses the minimum qualifications. If the applicant has the minimum qualifications, his information is stored in an inventory and can be efficiently screened against multiple job openings having different employment criteria. The present invention is also capable of accepting written narrative responses and automating a portion of the rating process for these responses, thereby increasing the efficiency of the screening process while lowering the time and expense required to evaluate all applicants for an available vacancy.

### BRIEF SUMMARY OF THE INVENTION

The invention described is a Web-based method for identifying applicants with the appropriate qualifications for available positions. One embodiment of the invention can provide a complete environment to manage the entire staffing process with specialized interfaces for the Human Resources (HR) specialist, the job-seeker, assessors, hiring officials, and other users. The method may implement a deferred rating procedure wherein the application is initially screened only for minimum qualifications, or some other sub-set of required qualifications, in a parent assessment. Then, prior to filling each job from the inventory resulting from the parent assessment, one of multiple child assessments is applied. Each child assessment is comprised of a subset of the questions that are in the parent assessment and are the most important for a specific position being filled. The invention also allows reviewers located throughout the country to evaluate and score written narrative questions without converging upon one location to obtain consensus scores.

### DETAILED DESCRIPTION OF THE INVENTION

The invention is composed of a broad set of functions which are combined to create an automated, Web-based method of posting and filling job vacancy announcements. The method operates by receiving applications, applying an optional, deferred rating procedure, then applying a more focused child rating procedure specifically tailored to a particular vacancy. This method provides a complete environment to manage the entire staffing process with specialized interfaces for the HR specialist, the job-seeker, assessors, hiring officials, and other users.

The disclosed method is extremely flexible in design and can be modified through the use of modules that add specifically tailored capabilities to the system as needed. For example, if questions requiring written narrative answers are included in an application, an assessor module is used to assist in rating the answers. Numerous other modules can be interfaced with the system to enhance functionality according to the needs of the applicants or the human resource professionals responsible for filling a particular job opening.

Initially, the HR user receives requests to fill vacant positions, either electronically or by other means. The HR user then sets up a vacancy record within the system. At this point, the HR user makes a determination whether, on the one hand, only one or a few positions will be filled and the preference is for specialized short term recruiting to fill all positions within, for example, 90 days, or on the other hand, whether a larger number of positions will be filled over a greater period of time. In the former case, the HR user sets up the vacancy as a case exam, and in the latter case, the HR user sets up the vacancy as a register. This system is, therefore, robust and scalable and able to accept and rapidly process extremely high volumes of applications according to the particular needs of the HR user.

A vacancy announcement is then created which can contain any descriptive information relating to the job, including the type of position, the geographic location, the pay range for the position and the period of eligibility. The announcement may also contain a list of required supporting documents such as a resume, recommendations, and evaluations.

The system is capable of accepting applications submitted via a Web-based questionnaire or sent by facsimile, and supporting documents submitted by electronic upload or sent in facsimile or hard copy and scanned into the system. Once submitted into the system, the applicants' qualifications and supporting documents are placed into inventory and may later be referenced or evaluated against a set of predefined criteria.

When multiple positions may be filled from a single vacancy announcement, it is possible that there are significant differences among the positions, even though they have the same basic qualification requirements. These differences may mean that individual applicants may be more qualified for certain positions than others. It is often uneconomical or impractical to take all potential positions into account when performing the initial rating, so instead, a part of the rating process is deferred.

For example, when a register is established, the HR user also makes a determination whether a deferred rating process will be employed. Deferred rating means that all applicants will be screened initially for minimum qualifications in order to be entered on the register of potential job applicants. A determination of the final ratings, however, is deferred, usually until shortly prior to the decision regarding which applicants will be referred for final evaluation.

As an individual request is received from an HR user, applications on the register are rated to arrive at a score for that particular referral. The system keeps track of the initial qualifications determination, all referrals for a given applicant, and the rating the applicant received for each individual job for which he was referred. When the deferred ratings process is used, an applicant's scores will vary from one position to the next and their records will reflect their rating for each position instead of one single rating.

The deferred ratings process makes it possible for HR users to use a single job announcement to recruit for a wide variety of related positions, and assure that the best qualified applicants for a given position are always given consideration. This process also benefits the applicant because he or she need only apply one time for consideration for multiple related positions over a prolonged period of time.

Deferred rating functionality is provided by permitting the HR user to create a parent assessment that comprises all the questions to which the applicant will be asked to respond. When a request for the staffing of a particular position is received, the HR user creates a child assessment comprising a subset of the parent assessment. The system then uses the child assessment when assigning a final rating relative to the request. The HR user can weight questions in the child assessment, for example, by giving certain question double or triple weight, as may be appropriate to support selective or quality ranking factors.

The system also supports the use of a category rating. In general, by default, referral lists of qualified applicants are issued in score order. When the category rating system is used, the HR user is permitted to specify the number of categories, the names of the categories, and the scores required for placement in each category. When the final referral list is issued, the HR user usually selects an applicant within the highest category. When the supply of applicants in the highest category is exhausted, the hiring official moves on to the next category for other qualified applicants.

The method of the invention is highly flexible for the HR user, who is permitted to manage a comprehensive assessment process. For example, the HR user first develops an assessment plan by which the applicants will be rated. As part of this plan the HR user may either author his or her own plan or reuse one from an assessment library. In the past, the assessment plan usually had one component. However, the invention is capable of processing multiple assessment components into an integrated, highly flexible assessment plan.

When multiple components are used, they can be sequenced as successive hurdles, such that only those applicants who successfully pass a hurdle may go on to the next. The HR user may modify the sequence of hurdles to optimize the process for both efficiency and ability to isolate and identify the most qualified applicants for a particular position. This hurdles approach is highly efficient and economical. For instance, low cost screening procedures such as qualifications questionnaires may be used for the first hurdle, or preliminary initial screens. By using this method, only a small number of applicants need be assessed using more predictive but expensive and time consuming methods, such as personal structured interviews, written tests, assessment centers, and written narrative responses.

The system also supports the ability to efficiently optimize the process of implementing a focused questionnaire assessment. For instance, when a deferred rating procedure is to be used, multiple, similar jobs may be filled from the same register. The system has the capability of identifying the specific questions most applicable to a particular position and to skip those questions that are irrelevant or only marginally relevant to a particular position. This process limits the burden on applicants who might otherwise have to answer hundreds of questions that are not predictive of job success for the particular position they seek.

The system also allows the HR user to modify the weight given to each response given on a questionnaire. Also, using a questionnaire builder, an HR user can create questionnaires or may import text documents created in other environments. The preferred embodiment of the invention may also be set to give the applicant users the ability to see, print, or update their questionnaire responses.

The system is highly flexible in the method by which the applicant users are permitted to answer the questionnaire. If desired, the HR user can determine whether or not spell checking is enabled, can randomize the sequence of questions presented to the applicant user, can limit the time available for a portion or entire questionnaire, and can insert instructions for particular questions or sets of questions.

Written answers to questions pose a particular problem for automated systems. While computers can be used to score written answers, the results are often less than optimal as scoring written answers is inherently subjective. To assure objectivity in the rating process when narrative responses are scored by human raters, an employer will usually require consensus among multiple raters on each narrative response from each applicant. The time and expense of having human reviewers converge upon a location to score hundreds of applications and reach consensus on each can be prohibitive. Therefore, the present system is also equipped with an assessor module for use when a particular job posting requires written narrative answers.

The assessor module uses the written answers applicants provided in electronic format or written on paper and scanned into the system by the HR user. The assessor module distributes the written answers to a team of scorers. Since the system is electronic, individuals throughout the country may work together efficiently and inexpensively. Using the assessor module the HR user may: manage a team of assessor/raters as individuals or as teams; assign raters certain quotas; provide raters instructions; define the accepted range of scores for a particular assessment; and specify the specific rules governing reaching consensus scores for a particular assessment.

After the scores are entered by the scorers, the assessor module may be set to either automatically apply the consensus algorithm to arrive at a consensus score from the individual raters' scores or negotiate a consensus between the scoring team. If consensus is required, the assessor module will analyze the scores submitted by the teams and if the scores diverge by a predetermined amount, the assessor module will notify the team members that an additional action to resolve the difference and reach consensus is required.

Once an acceptable score is obtained for a particular application, the assessor module writes the score to the applicant's file and then applies the rating process as described above. This innovative method allows for the scoring of written narrative answers in an efficient, cost effective manner. It also allows for increased automation of a traditionally manual process.

The previous discussion focused on the features of the system primarily from the HR user's perspective. The method of the invention is also much more efficient and effective for job applicants. In the preferred embodiment of the invention, the applicant begins the application process online by arriving at the system's dedicated URL. It is to be understood that other methods are well-known in the art for allowing electronic devices to communicate and exchange information. The invention is in no way limited to a particular path, such as the World Wide Web, for information to be communicated between the applicant and the application system.

The job applicant may access the system either directly or through a link provided by a job posting system. Once connected to the present system, the applicant is provided a questionnaire that collects preliminary information such as contact information. The applicant is then required to answer the questionnaire selected by the HR user for the particular job vacancy.

After the questionnaire is completed, the applicant may upload files using the system's document upload service. The type of required or accepted documents are determined in advance by the HR user. The document upload service is capable of handling multiple electronic file types. The service then scans each file for computer viruses before converting them to .pdf (Adobe Portable Document Format) and storing them in memory. The user may also be provided a fax cover sheet pre-populated with information needed to link any faxed documents to the applicant and a particular vacancy.

The preferred embodiment of the invention also contains an application manager where applicants can see the status of their application packages and follow a checklist of all the steps that must be completed before their application can be finalized. Using the application manger, applicant users can review and manage the documents they submitted, reuse documents for other positions, view, print and update questionnaires they submitted, review copies of all notifications the system has sent and update their contact information and other information in the personal profiles.

Unlike the prior art, the present invention is robust and scalable to handle extremely high volumes of applications simultaneously. Using the invention, vacancies can be filled quickly, often within minutes, because it provides for applicants to be recruited and rated in advance and in large numbers, then referred with or without deferred rating when vacancies occur. The system maintains communication with applicants and eliminates delays which might cause an applicant to look elsewhere for employment.

By providing the capability for multiple assessments staged as hurdles, and by making it possible to collect and quickly rate narrative responses, employers can afford to perform very thorough candidate assessments with higher predictive value and lower cost. The system also reduces the burden on applicants because it maximizes opportunities to reuse information. And, because the system can handle all documents electronically, the costs and delay associated with paper filing are virtually eliminated.

One of ordinary skill in the art would be able to use an available computer programming language to implement both the system and method described above, using only ordinary skill in the programming art. And, since numerous modifications and variations would occur to one of ordinary skill in the art, it is not desired to limit the invention to the exact sequence or construction illustrated and described, and accordingly, all suitable variations or modifications and equivalents may be resorted to, failing within the scope of the invention.

We claim:

1. An automated method for evaluating employment applications, comprising the steps of:
receiving an employment application;
conducting an evaluation of said application using a deferred rating module;
generating a first rating based on said evaluation using said deferred rating module;
conducting an evaluation of said application using an assessor module;
generating a second rating based on said evaluation using said assessor module; and
generating an overall application rating from said first and second ratings.

2. The method of claim 1, wherein said step of evaluating said application using a deferred rating module comprises the steps of:
creating a first assessment;
evaluating said application against said first assessment;
entering the result of said assessment on a register;
creating a second assessment; and
further evaluating said application against said second assessment.

3. The method of claim 2, wherein the second assessment is a series of questions selected from the first assessment.

4. The method of claim 2, further comprising, after the step of evaluating the application against the first assessment, the step of determining whether said application possesses certain minimum application requirements.

5. The method of claim 1, wherein said step of conducting an evaluation of said application using an assessor module comprises the steps of:
preparing a set of questions calling for narrative responses;
receiving said narrative responses as part of said application;
distributing said responses to a plurality of evaluators; and
collecting numerical evaluations of said responses from each of the plurality of evaluators.

6. The method of claim 5, wherein the step of combining said evaluations further comprises the step of analyzing the numerical evaluations of said narrative responses to determine if a consensus evaluation exists.

7. The method of claim 6, wherein said step of analyzing the numerical evaluations is followed by a step of obtaining a further evaluation of said narrative responses to generate a consensus rating.

8. The method of claim 5, wherein said narrative responses are obtained from responses to written essay questions.

9. The method of claim 5, wherein said narrative responses are obtained from interviews of applicants.

10. The method of claim 5, wherein said evaluators are located at a plurality of remote locations.

11. A module-based automated system for evaluating employment applications, comprising:
a deferred rating module; and
an assessor module.

12. The system of claim 11, wherein said deferred rating module comprises:
an interface for compiling a parent assessment containing a plurality of questions; and
an interface for compiling a child assessment from the questions included in said parent assessment.

13. The system of claim 12, wherein the interface for compiling a child assessment permits selective weighting of questions selected from said parent assessment.

14. The system of claim 11, wherein said assessor module comprises:
a central computer for storing narrative responses obtained from a plurality of employment applicants;
an interface for remotely accessing said computer and transmitting evaluations of said narrative responses.

15. The system of claim 11, wherein said assessor module additionally comprises a system for comparing a plurality of evaluations for a consensus rating, and requiring further evaluation if said consensus rating does not exist.
